(19) United States
(12) Patent Application Publication
(10) Pub. No.: US 2026/0125259 A1
(43) Pub. Date: May 7, 2026

(54) ADJUSTABLE NECK ALIGNMENT ASSEMBLY

(71) Applicant: Fogg Filler Company, LLC, Holland, MI (US)

(72) Inventors: Randall JOHNSON, Grand Haven, MI (US); Todd KEMME, Jenison, MI (US)

(21) Appl. No.: 19/371,626

(22) Filed: Oct. 28, 2025

Related U.S. Application Data
(60) Provisional application No. 63/715,146, filed on Nov. 1, 2024.

(51) Int. Cl. B67C 3/26

(52) U.S. Cl. CPC B67C 3/26

(57) ABSTRACT

An adjustable neck alignment assembly for aligning a fill structure to control a fill level of flowable material being dispensed within a container is provided. The adjustable neck alignment assembly includes an alignment structure, and a height adjustment knob configured to be rotated around the alignment structure to move a position of a component that controls a depth position, of a flowable material fill tube of a fill valve, within the container during filling to control an amount of flowable material being dispensed within the container

### TECHNICAL FIELD

The present disclosure generally relates to filling machines used to fill containers such as bottles and, more specifically, to an attachment and adjustment assembly usable in such filling machine.

### BACKGROUND

Liquid dispensing equipment for filling containers with liquid typically requires placement and attachment with respect to multiple different positions for different containers being filled. However, existing liquid dispensing equipment may not be easily attached to containers and placed in different filling positions resulting in inaccurate and complex processes requiring multiple steps.

### SUMMARY

In one aspect, an adjustable neck alignment assembly for aligning a fill structure to control a fill level of flowable material being dispensed within a container is provided. The adjustable neck alignment assembly includes an alignment structure, and a height adjustment knob configured to be rotated around the alignment structure to move a position of a component that controls a depth position, of a flowable material fill tube of a fill valve, within the container during filling to control an amount of flowable material being dispensed within the container.

In another aspect, a filling apparatus for a container includes a fill tube for delivering liquid into the container, and an adjustable neck alignment assembly associated with the fill tube and including: an alignment structure; a height adjustment knob disposed about at least part of the alignment structure and configured to be rotated around the alignment structure; wherein an axial position of the height adjustment knob relative to the alignment structure remains fixed during rotation of the height adjustment knob; wherein the height adjustment knob is operatively linked such that rotation of the height adjustment knob causes axial movement of a position of a fill tube depth setting structure relative to both the alignment structure and the height adjustment knob; wherein the position of the fill tube depth setting structure sets an axial depth that the fill tube will achieve within a container during a filling operation

Various implementations disclosed herein include devices, systems, and methods that implement an adjustable neck alignment assembly for aligning a fill structure to control a fill level of flowable material being dispensed within a container. The adjustable neck alignment assembly may include a height adjustment knob configured to be rotated around an alignment structure and create vertical movement of a flowable material fill tube to control a depth position and a fill valve of the flowable material fill tube within the container to control an amount of flowable material being dispensed within the container.

In some implementations, the adjustable neck alignment assembly includes a spring plunger ball structure configured to be released from and engaged with openings of the alignment structure during rotation of height adjustment knob to engage different fixed positions of the height adjust knob thereby setting differing fixed depth positions for the flowable material fill tube within the container.

In some implementations, the adjustable neck alignment assembly includes a spacer seal configured to be slidably placed over an outer diameter of an upper portion the flowable material fill tube to maintain an airtight seal during movement of the flowable material fill tube.

In some implementations, the adjustable neck alignment assembly includes at least one pin structure placed within an opening of a valve opening ring structure such that a portion of the at least one pin structure is configured to linearly move within helical grooves of the height adjustment knob during rotation thereby providing variable length liquid fill level adjustment capabilities that cause movement of the flowable material fill tube.

In some implementations, the adjustable neck alignment assembly includes a retainer structure configured to attach a specific type of container to the assembly for allowing the flowable material to dispensed within the container. In some implementations, the retainer structure is removably attached to the assembly for quick removal and replacement by a differing retainer structure specific to differing type of container.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A and 1B illustrate positional cross-sectional views of a fill structure that includes an adjustable neck alignment assembly and a fill valve assembly, in contact with the upper end of a bottle for purpose of filling, in accordance with some implementations.

FIG. 2A illustrates a cutaway perspective view of the adjustable neck alignment assembly of FIGS. 1A and 1B, in accordance with some implementations.

FIG. 2B illustrates an exploded view of the adjustable neck alignment assembly of FIG. 2A, in accordance with some implementations.

FIGS. 2C-2M illustrate perspective views of various components of the adjustable neck alignment assembly of FIGS. 2A and 2B, in accordance with some implementations.

FIG. 3 illustrates a perspective view of various components of a fill valve assembly, in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

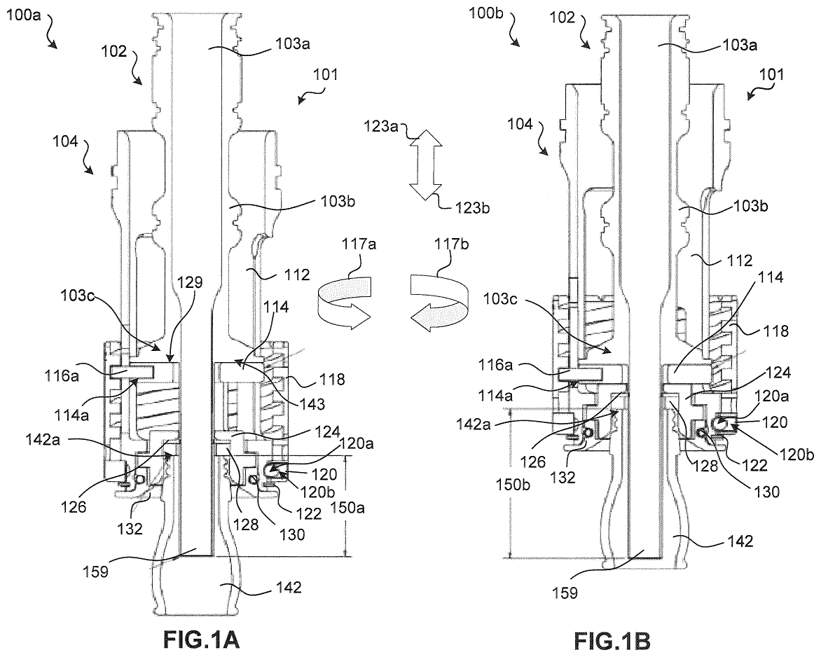

FIGS. 1A and 1B illustrate cross-sectional views 100a and 100b of a fill structure 101 that includes an adjustable neck alignment assembly 104 and a fill valve assembly 102 positioned with respect to a container 142 (e.g., a bottle) for performing a liquid dispensing process, in accordance with some implementations.

FIG. 1A illustrates view 100a of fill structure 101 that includes adjustable neck alignment assembly 104 placed in a first position with respect to fill valve assembly 102.

In some implementations, fill valve assembly 102 includes a fill tube 103a (including a fill valve) placed within an outer sleeve assembly 103b attached to an opening ring 103c. Fill valve assembly 102 is movably attached to adjustable neck alignment assembly 104.

In some implementations, adjustable neck alignment assembly 104 includes an alignment structure 112, a valve opening ring structure 114 accepting at least one pin/dowel 116a within an opening 114a, a height adjust knob 118 (which, in the depicted embodiment, is cylindrical), spring plungers 120 that each include a spring plunger ball 120a within a housing 120b, a retaining ring 122, a bottle retainer/guide 124, a gasket 126, a spacer seal 128, a spring retainer 130, and a bottle guide retainer 132.

In some implementations, the height adjust knob 118 is configured to be manually rotated in a direction 117a or 117b (e.g., a clockwise or counterclockwise direction) to provide variable length liquid fill level adjustment capabilities that allow movement of fill tube 103a in directions 123a and 123b (e.g., a vertical direction such as up or down) to control (e.g., increase or decrease) a depth position of fill tube 103a and an associated air vent 159 (of fill tube 103a) within container 142. During rotation of the height adjust knob 118, a relative axial position between the knob 118 and the alignment structure 112 remains the same. The depth position of fill tube 103a within container 142 is configured to control a fill level of liquid being dispensed within container 142. For example, view 100a illustrates valve opening ring structure 114 placed in a raised position causing a specified portion 150a of fill tube 103a to be located within container 142 thereby regulating a fill height of liquid being dispensed within container 142. Valve opening ring structure 114 placed in a raised position effectively sets a space between a top portion 142a of container 142 and a fluid level thereby accommodating different container (bottle) sizes and/or desired liquid fill levels. In some implementations, liquid is dispensed within container 142 in response to top portion 142a of container 142 making contact with (and being sealed by) spacer seal 128 thereby enabling a fill valve of fill tube 103a to open and dispense liquid. When the container 142 moves up to engage with the fill structure, a top portion 142a of container 142 makes contact with spacer seal 128 thereby causing the neck alignment structure (112 and 118 together) to move upward until a top surface 129 of valve opening ring structure 114 contacts and pushes up against a bottom surface 143 of opening ring 103c to enable a fill valve to open.

FIG. 1B illustrates view 100b of fill structure 101 that includes adjustable neck alignment assembly 104 placed in a second position with respect to fill valve assembly 102.

In contrast with view 100a of FIG. 1A, view 100b of FIG. 1B illustrates a position fill valve assembly 102 subsequent to rotation of height adjust knob 118 causing an increased depth position of fill tube 103a within container 142. The increased depth position of fill tube 103a within container 142 is configured to modify the fill level of liquid being dispensed within container 142 (e.g., with respect to a fill level of liquid being dispensed within container 142 as illustrated in view 100a of FIG. 1A). For example, view 100b illustrates valve opening ring structure 114 in a lowered position, relative to alignment structure 112, causing a specified portion 150b of fill tube 103a to be located within container 142 thereby regulating a differing fill height of liquid being dispensed within container 142. Valve opening ring structure 114 placed in a lowered position effectively sets a space (differing from the space described with respect to FIG. 1A) between top portion 142a of bottle and a fluid level thereby accommodating different bottle sizes and/or desired liquid fill levels. Similar to view 100a of FIG. 1A, view 100b enables liquid to be dispensed within container 142 in response to top portion 142a of container 142 making contact with (and being sealed with respect to) spacer seal 128 thereby causing a fill valve of fill tube 103a to open for dispensing liquid.

In some implementations, the adjustable neck alignment assembly 104 may be integrated with filling valves of the types generally shown and described in U.S. Pat. Nos. 11,365,105; 10,597,277 and/or 10,233,067, each of which is incorporated herein by reference in its entirety. However, incorporation of adjustable neck alignment assembly 104 into other filling valve assemblies is also possible.

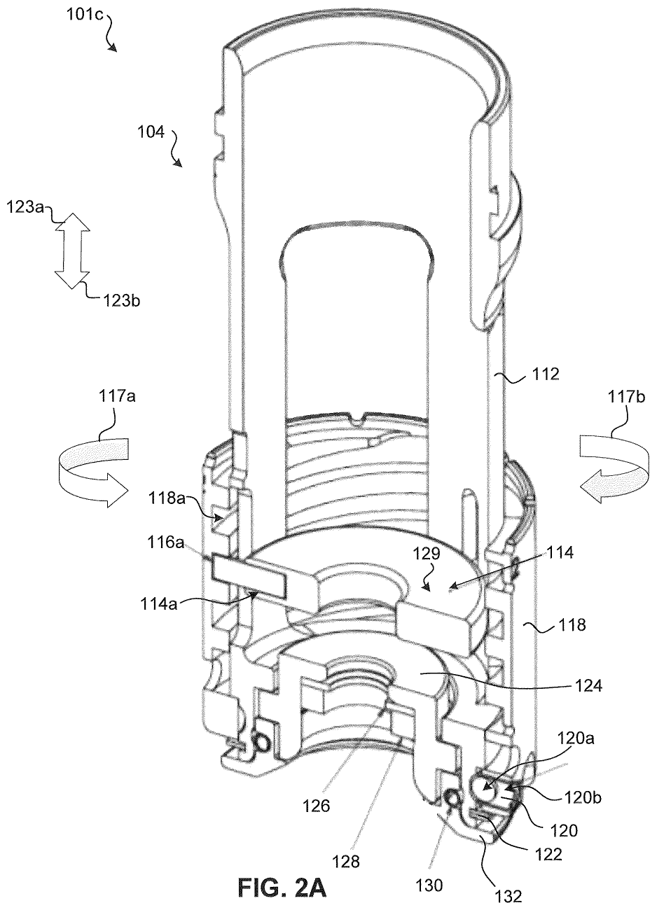

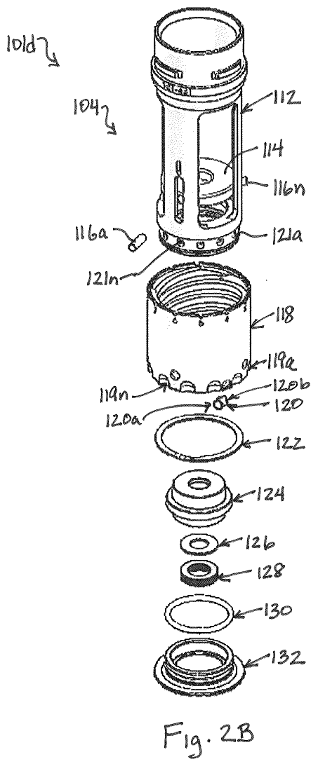

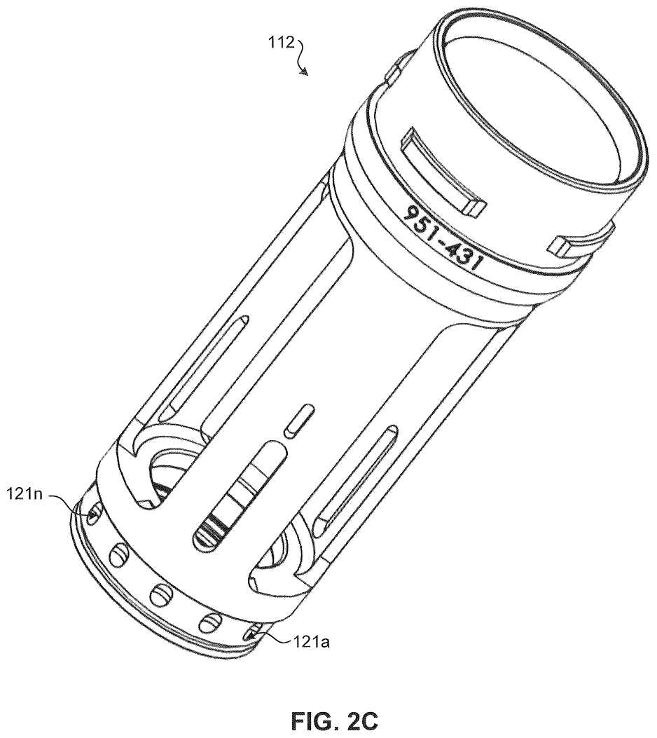

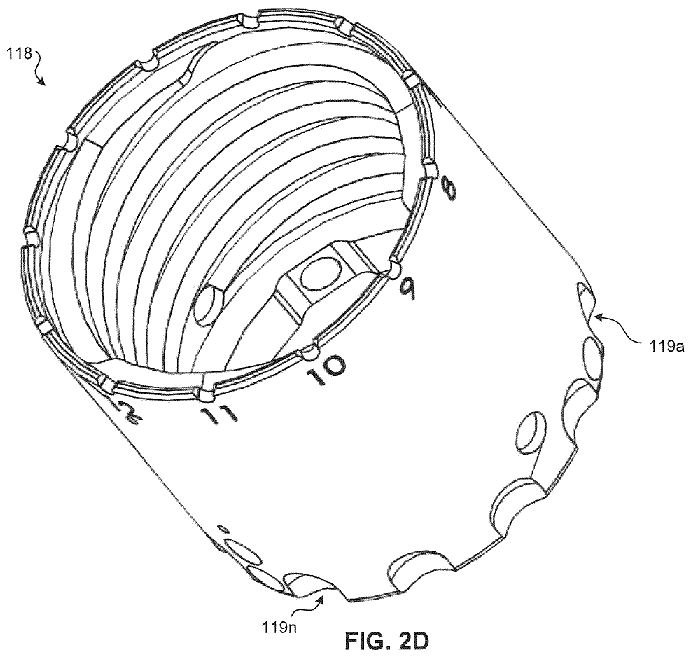

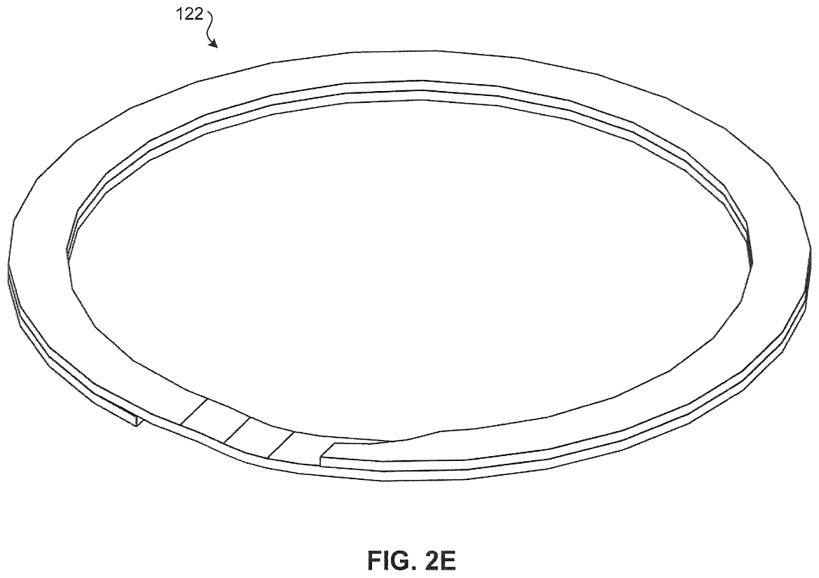

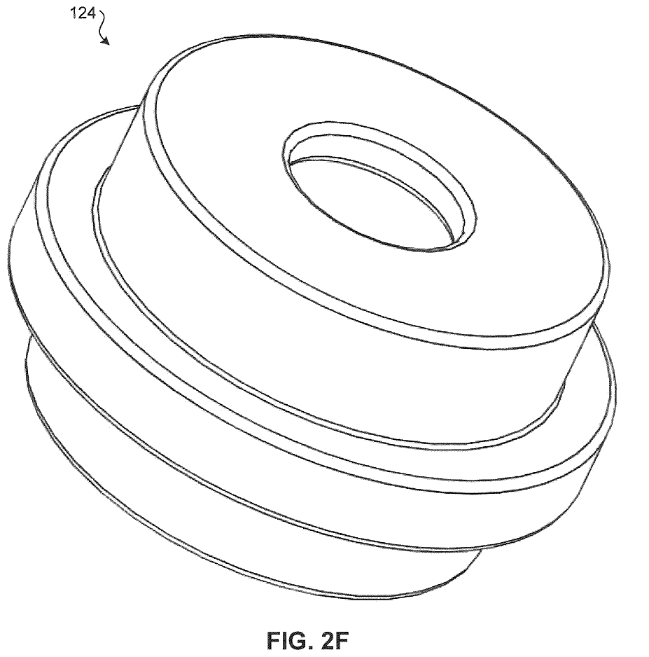

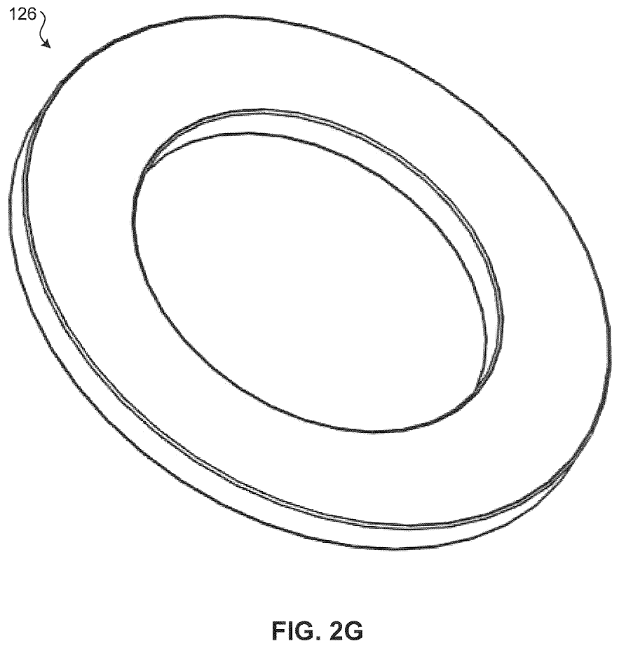

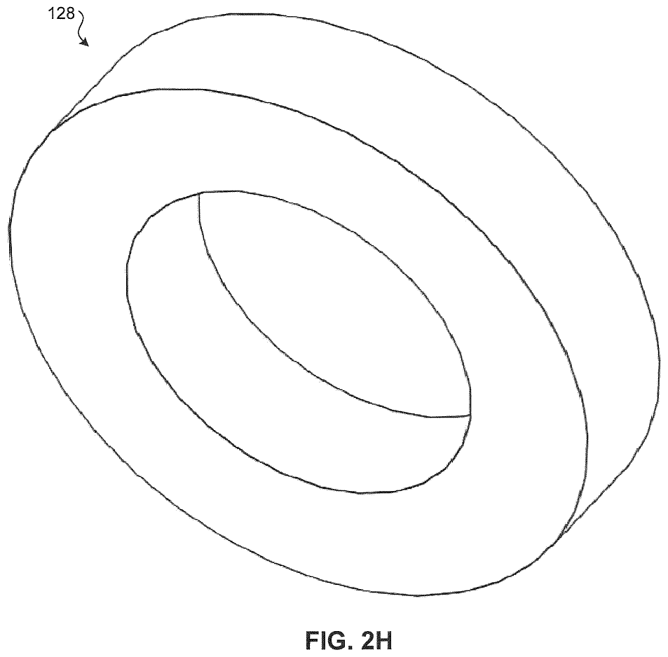

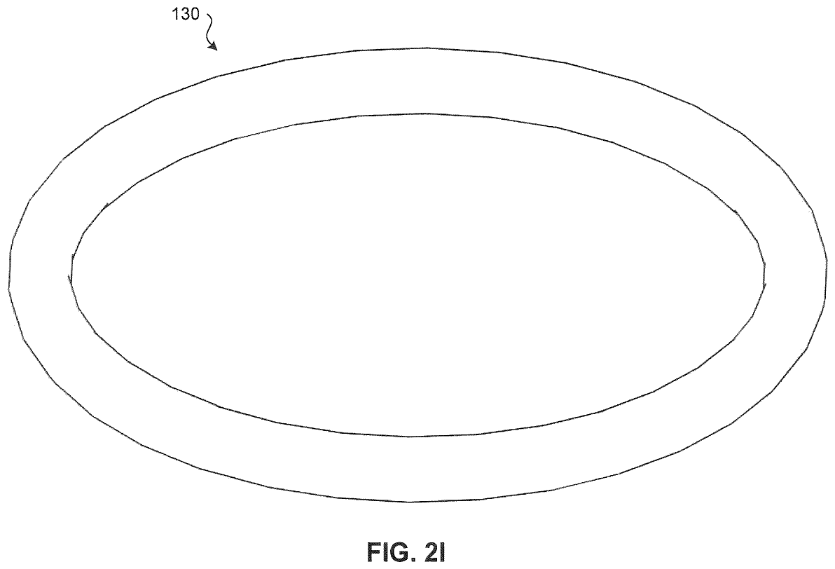

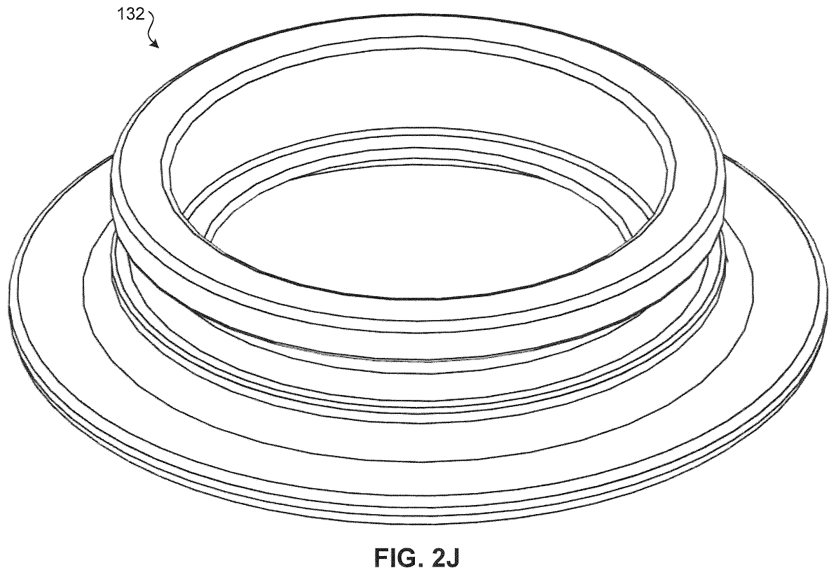

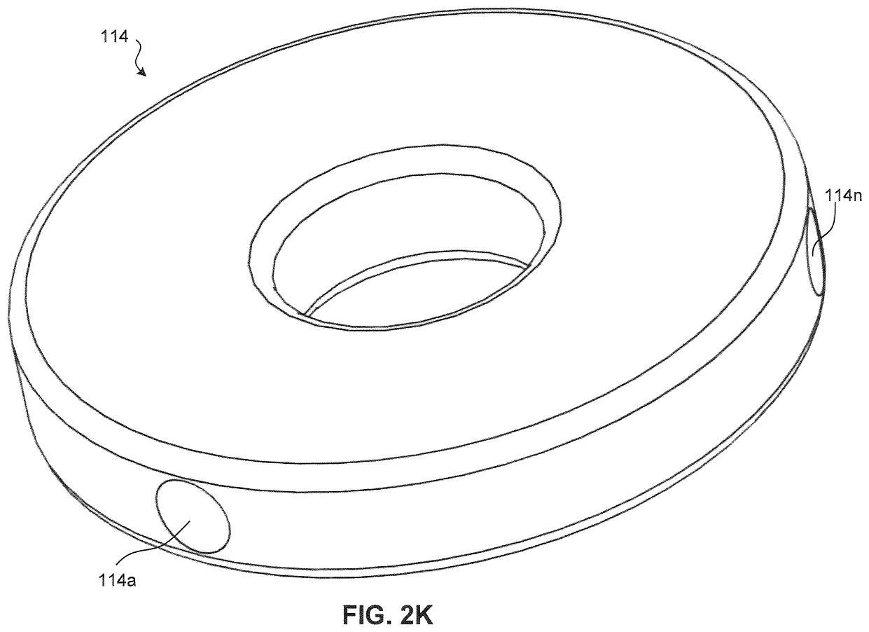

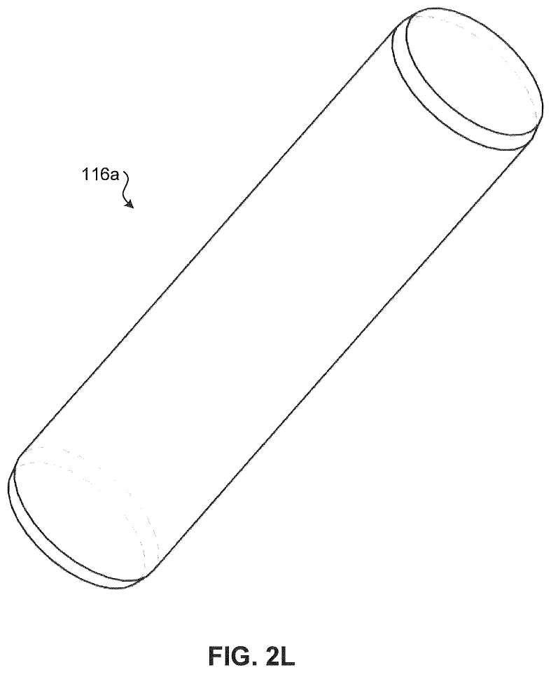

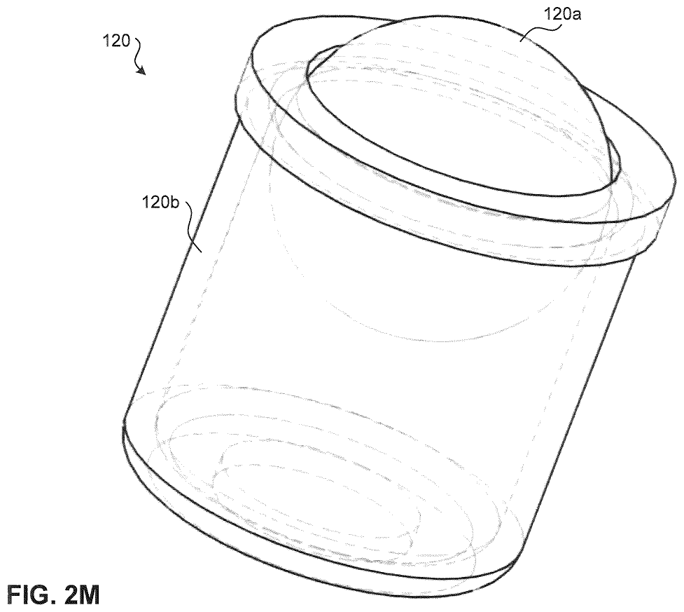

FIG. 2A illustrates a cutaway perspective view 101c of adjustable neck alignment assembly 104 of FIGS. 1A and 1B, in accordance with some implementations.

Cutaway perspective view 101c of adjustable neck alignment assembly 104 includes a cutaway perspective view of alignment structure 112, valve opening ring structure 114 including at least one pin/dowel 116a within opening 114a, height adjust knob 118, spring plungers 120 that each include a spring plunger ball 120a within a housing 120b, retaining ring 122, bottle retainer/guide 124, a gasket 126, a spacer seal 128, a spring retainer 130, and a bottle guide retainer 132.

In some implementations, height adjust knob 118 is configured to be manually rotated in direction 117a or 117b (e.g., a clockwise or counterclockwise direction) thereby enabling a portion of at least one pin/dowel 116a within opening 114a of valve opening ring structure 114 to linearly move within helical grooves 118a (of height adjustment knob 118) during rotation. In some implementations, at least one pin/dowel 116a linearly moving within helical grooves 118a provides variable length liquid fill level adjustment capabilities that cause movement of a liquid fill tube (e.g., fill tube 103a of fill structure 103 as illustrated in FIGS. 1A and 1B) and valve opening ring structure 114 in directions 123a and 123b (e.g., a vertical direction such as up or down) to control (e.g., increase or decrease) a depth position of a liquid fill tube and an associated air vent within a bottle such as container 142 of FIGS. 1A and 1B.

In some implementations, liquid is dispensed within a bottle in response to a top surface 129 of valve opening ring structure 114 contacting and pushing up against bottom surface 143 of valve opening ring structure 114 of container 142 (i.e., as illustrated in FIGS. 1A and 1B) thereby enabling a fill valve of a liquid fill tube to open and dispense liquid.

In some implementations, spring plungers 120 in combination with alignment structure 112 and height adjust knob 118 (e.g., a clicker mechanism) may be used to adjust the liquid fill tube to specified fixed depths with respect to a bottle. For example, during rotation of height adjust knob 118, with sufficient force, in direction 117a or 117b, each spring plunger ball 120a may release from and engage with openings (e.g., openings 121a . . . 121n such as recessed portions of alignment structure 112 as illustrated in FIG. 2B). Likewise, each housing 120b may be mounted with in openings 119a . . . 119n (e.g., as illustrated in FIG. 2B) of height adjust knob 118. Each spring plunger ball 120 sequentially releasing from and engaging with openings of alignment structure 112 during rotation enables a clicker type mechanism to engage different fixed positions of height adjust knob 118 with respect to alignment structure 112 thereby setting differing releasably fixed or locked depth positions for a liquid fill tube within a bottle.

In some implementations, spacer seal 128 slides on an outer diameter of a liquid fill tube for allowing movement while still maintaining an airtight seal.

In some implementations, bottle retainer/guide 124 is configured to retain (to fill structure 103) a specific type (e.g., size, shape, etc.) of bottle for allowing liquid to be dispensed. The bottle retainer/guide 124 may removably attached (via bottle guide retainer 132) to adjustable neck alignment assembly 104 so that it may be quickly removed and replaced (e.g., a quick change) by another differing bottle retainer/guide that is specific to another type (e.g., size, shape, etc.) of bottle. Accordingly, multiple differing bottle retainer/guides may be used with fill structure 103 to allow for different types of bottles to be used for liquid dispensing.

FIG. 2B illustrates an exploded view 101d of adjustable neck alignment assembly 104 of FIGS. 1A-2A, in accordance with some implementations. Exploded view 101d of adjustable neck alignment assembly 104 includes an exploded perspective view of alignment structure 112 with openings 121a . . . 121n, valve opening ring structure 114 including at least one pin/dowel 116a within an opening, height adjust knob 118 with openings 119a . . . 119n, spring plungers 120 that each include a spring plunger ball 120a within a housing 120b, retaining ring 122, bottle retainer/guide 124, a gasket 126, a spacer seal 128, a spring retainer 130, and a bottle guide retainer 132.

FIG. 2C illustrates a perspective view of alignment structure 112 of the adjustable neck alignment assembly 104 of FIGS. 1A-2B, in accordance with some implementations.

FIG. 2D illustrate a perspective view of height adjust knob 118 (with openings 119a . . . 119n) of the adjustable neck alignment assembly 104 of FIGS. 1A-2B, in accordance with some implementations.

FIG. 2E illustrates a perspective view of a retaining ring 122 of the adjustable neck alignment assembly 104 of FIGS. 1A-2B, in accordance with some implementations.

FIG. 2F illustrates a perspective view of removable/replaceable bottle retainer/guide 124 of the adjustable neck alignment assembly 104 of FIGS. 1A-2B, in accordance with some implementations.

FIG. 2G illustrates a perspective view of gasket 126 of the adjustable neck alignment assembly 104 of FIGS. 1A-2B, in accordance with some implementations.

FIG. 2H illustrates a perspective view of spacer seal 128 of the adjustable neck alignment assembly 104 of FIGS. 1A-2B, in accordance with some implementations.

FIG. 2I illustrates a perspective view of spring retainer 130 of the adjustable neck alignment assembly 104 of FIGS. 1A-2B, in accordance with some implementations.

FIG. 2J illustrates a perspective view of bottle guide retainer 132 of the adjustable neck alignment assembly 104 of FIGS. 1A-2B, in accordance with some implementations.

FIG. 2K illustrates a perspective view of valve opening ring structure 114 (with openings 114a . . . 114n) of the adjustable neck alignment assembly 104 of FIGS. 1A-2B, in accordance with some implementations.

FIG. 2L illustrates a perspective view of pin/dowel 116a of the adjustable neck alignment assembly 104 of FIGS. 1A-2B, in accordance with some implementations.

FIG. 2M illustrates a perspective view of one of spring plunger balls 120 including plunger ball 120a within housing 120b operable with the adjustable neck alignment assembly 104 of FIGS. 1A-2B, in accordance with some implementations.

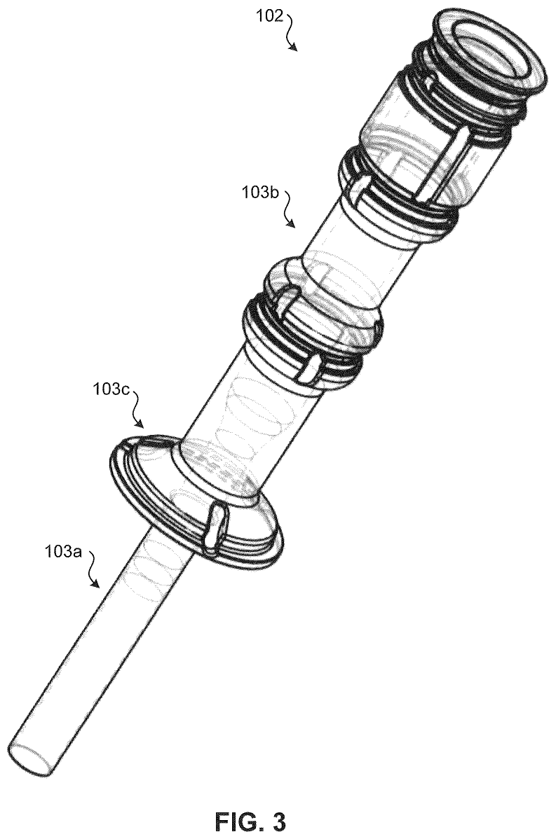

FIG. 3 illustrates a perspective view of fill tube 103a (including a fill valve) placed within outer sleeve assembly 103b attached to opening ring 103c of fill structure 103 of FIGS. 1A and 1B, in accordance with some implementations.

This written description describes the invention so as to enable a person of ordinary skill in the art to make and use the invention, by presenting examples of the elements recited in the claims. The detailed descriptions of those elements do not impose limitations that are not recited in the claims, either literally or under the doctrine of equivalents.

1. An adjustable neck alignment assembly for aligning a fill structure to control a fill level of flowable material being dispensed within a container, the adjustable neck alignment assembly comprising:
an alignment structure;
a height adjustment knob configured to be rotated around the alignment structure to move a position of a component that controls a depth position, of a flowable material fill tube of a fill valve, within the container during filling to control an amount of flowable material being dispensed within the container.

2. The assembly of claim 1, further comprising:
a spring plunger ball structure configured to be released from and engaged with openings of the alignment structure during rotation of the height adjustment knob to engage different fixed positions of the height adjust knob thereby setting differing releasably fixed depth positions for the flowable material fill tube within the container.

3. The assembly of claim 1, further comprising:
a spacer seal configured to be slidably placed over an outer diameter of an upper portion the flowable material fill tube to maintain an airtight seal during movement of the flowable material fill tube.

4. The assembly of claim 1, further comprising:
at least one pin structure placed within an opening of a valve opening ring structure that forms the component, wherein a portion of the at least one pin structure is configured to linearly move within helical grooves of the height adjustment knob during rotation via rotation of the height adjustment knob to control a distance that the flowable material fill tube will move into the container during filling.

5. The assembly of claim 1, further comprising:
a retainer structure configured to attach a specific type of container to the assembly for allowing the flowable material to be dispensed within the container, wherein the retainer structure is removably attached to the assembly for quick removal and replacement by a differing retainer structure specific to differing type of container.

6. The assembly of claim 1, wherein the component comprises a valve opening ring structure disposed within the alignment structure.

7. A filling apparatus for a container, comprising:
a fill tube for delivering liquid into the container;
an adjustable neck alignment assembly associated with the fill tube and including:
an alignment structure;
a height adjustment knob disposed about at least part of the alignment structure and configured to be rotated around the alignment structure;
wherein an axial position of the height adjustment knob relative to the alignment structure remains fixed during rotation of the height adjustment knob;
wherein the height adjustment knob is operatively linked such that rotation of the height adjustment knob causes axial movement of a position of a fill tube depth setting structure relative to both the alignment structure and the height adjustment knob;
wherein the position of the fill tube depth setting structure sets an axial depth that the fill tube will achieve within a container during a filling operation.

8. The filling apparatus of claim 7, wherein the fill tube depth setting structure comprises a valve opening ring structure disposed within the alignment structure, wherein a projection extends from the ring structure and is engaged in a helical groove of the height adjustment knob, wherein rotation of the height adjustment knob causes axial movement of the ring structure.

9. The filling apparatus of claim 8, wherein the projection extends through an opening in the alignment structure in order to engage within the helical groove.

10. The filling apparatus of claim 8, wherein, during a filling operation of the filling apparatus, a relative axial movement between the fill tube and the neck alignment structure occurs.

11. The filling apparatus of claim 10, wherein the fill tube is associated with a sleeve assembly, wherein the neck alignment structure is disposed about the sleeve assembly, wherein a bottle contacting component is carried by the neck alignment structure, wherein an axial force between the container and the bottle contacting component causes relative axial movement between the neck alignment structure and the sleeve assembly until a part of the sleeve assembly makes the contact with the ring structure.
